(19) United States
(12) Patent Application Publication
(10) Pub. No.: US 2023/0153649 A1
(43) Pub. Date: May 18, 2023

(54) METHODS AND SYSTEMS FOR DETERMINING A LIKELIHOOD OF AUTONOMOUS CONTROL OF A VEHICLE

(71) Applicant: Capital One Services, LLC, McLean, VA (US)

(72) Inventors: Galen RAFFERTY, Mahomet, IL (US); Grant Eden, Menlo Park, CA (US); Jeremy Goodsitt, Champaign, IL (US); Samuel Sharpe, Cambridge, MA (US); Anh Truong, Champaign, IL (US)

(21) Appl. No.: 17/529,577

(22) Filed: Nov. 18, 2021

(51) Int. Cl. G06N 5/04; G06N 5/02

(52) U.S. Cl. CPC G06N 5/04; G06N 5/022

(57) ABSTRACT

Disclosed are methods and systems for determining the likelihood that a vehicle is under autonomous control. For instance, a method may include receiving a request for an autonomous operation score of the vehicle; obtaining one or more permissions to access observation data from one or more sources; and generating a vehicle observation profile based on the observation data from the one or more sources. The method may further include determining whether the vehicle observation profile is indicative of one or more reference patterns; generating an autonomous control score based on the determination that the vehicle observation profile is indicative of the one or more reference patterns; and providing the autonomous operation score to a user.

### TECHNICAL FIELD

Various embodiments of the present disclosure relate generally to methods and systems for determining if an object is being autonomously controlled and, more particularly, to methods and systems for determining the likelihood that a vehicle is under autonomous control.

### BACKGROUND

While autonomous objects and vehicles such as drones and cars with autonomous driving systems become increasingly common in the air and on the roads, it can sometimes be difficult to distinguish between objects or vehicles under human control as opposed to those operating autonomously. Being unable to distinguish between objects or vehicles under human control and those operating autonomously may make it more difficult for a person or entity to predict how the object or vehicle will respond to various stimuli that may be present in the environment. For example, while an autonomously controlled vehicle may exhibit consistent attentiveness, a human controlled vehicle may demonstrate occasional lapses in awareness as a human operator only has a finite amount of attention to use. This difficulty predicting the behavior of objects and vehicles in the environment can pose challenges to navigating the environment safely and responsibly. In some instances the additional factors of safety and additional berth granted to an object or vehicle can adversely impact the ability to efficiently navigate the environment.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, methods and systems for determining the likelihood that a vehicle is under autonomous control are disclosed. The methods and systems may provide an ability to adjust the speed or direction of a user's vehicle (or other object) based on an accurate identification of nearby vehicles (or other objects) under autonomous control.

For instance, a method of determining a likelihood of autonomous control of a vehicle may include receiving a request for an autonomous operation score of the vehicle; obtaining one or more permissions to access observation data from one or more sources; and generating a vehicle observation profile based on the observation data from the one or more sources. The method may further include determining whether the vehicle observation profile is indicative of one or more reference patterns; generating an autonomous control score based on the determination that the vehicle observation profile is indicative of the one or more reference patterns; and providing the autonomous operation score to a user.

A system may include a memory storing instructions; and a processor executing the instructions to perform a process. The process may include receiving a request for an autonomous operation score of the vehicle; obtaining one or more permissions to access observation data from one or more sources; and generating a vehicle observation profile based on the observation data from the one or more sources. The process may further include determining whether the vehicle observation profile is indicative of one or more reference patterns; generating an autonomous control score based on the determination that the vehicle observation profile is indicative of the one or more reference patterns; and providing the autonomous operation score to a user.

A system may include one or more observational sensors including at least one camera, a memory storing instructions, and a processor executing the instructions to perform a process. The process may include receiving a request for an autonomous operation score of the moving object; obtaining one or more permissions to access observation data from one or more sources; and generating a vehicle observation profile based on the accessed observation data from the one or more sources. The process may further include determining whether the vehicle observation profile is indicative of one or more reference patterns; generating an autonomous control score based on the determination that the vehicle observation profile is indicative of the one or more reference patterns; providing the autonomous operation score to a user; and modifying at least one of a user vehicle speed or a user vehicle direction based at least in part on the autonomous operation score.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary block diagram of a system environment for determining a likelihood of autonomous control of an object, according to one or more embodiments.

FIG. 2 depicts a flowchart of an exemplary method of determining a likelihood of autonomous control of an object, according to one or more embodiments.

FIG. 3 depicts an exemplary system that may execute techniques presented herein.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In general, the present disclosure is directed to methods and systems for determining if an object is being autonomously controlled and, more particularly, to methods and systems for determining the likelihood that a vehicle is under autonomous control. For example, a method of the present disclosure may begin with the receipt of a request for an estimate of the likelihood that a vehicle is under autonomous control, and the estimate may take the form of, for example and not limitation, a score or index value. The request may be user-generated or automatically generated by a system such as a navigation system or device application. The method may then proceed to gain access to the information sources that will be used for the analysis, such as access to a camera on a device, a database of reference patterns, and/or access to a network of sensors such as those employed by an air traffic control entity. Having been granted access, the method may proceed by generating a profile for the vehicle or vehicles that includes the observation information collected from the sources.

The profile can then be analyzed to determine if the movement patterns or other available observations are substantially similar to one or more reference patterns indicative of human or autonomous control. For example, these patterns may include fine movements that a human would have difficulty replicating or imprecise movements that an autonomous system would likely not generate. Based on this analysis and the determination of the presence of one or more reference patterns, the method may proceed to generate the requested estimate and/or prediction, and then provide the analysis to the requesting entity.

Systems and methods in accordance with the present disclosure may be employed in a number of different situations including vehicle navigation, remote evaluation of an environment (e.g., ok to launch/fly a kite), and asset monitoring. In an exemplary vehicle navigation application, a human or autonomous operator of a vehicle may use sensors to scan the environment around the vehicle and analyze any objects observed in the environment to be better able to predict the behavior of those objects. On a roadway, a system in accordance with the present disclosure may determine and provide the likelihood that a nearby vehicle is under autonomous control to determine how close to follow and/or how much leeway to provide when changing lanes.

Another application of systems and methods in accordance with the present disclosure may be to evaluate an environment such as an airspace or waterway for safety. A user may use a phone or other device to determine if an airspace is safe to operate a drone or to fly a kite. If the vehicles in the airspace are determined to be autonomously operated, the user may have more confidence that the vehicles won't collide with their drone or kite. In the event that the system determines that a number of vehicles operating in the airspace are human controlled, the user may elect not to launch or fly their device.

In some situations, an environment, such as a warehouse or worksite, may have a mix of manually operated and autonomously operated assets and/or vehicles present, and may be transporting large, expensive, or potentially hazardous materials. In that type of environment, it may be beneficial for a user managing the environment to be able to distinguish between those assets and/or vehicles. For example, when managing a mining site, a user may elect to intervene or not intervene when pieces of equipment are approaching one another based on the knowledge that they are or are not under autonomous control. Autonomously controlled machinery may be networked such that human errors can be avoided, thereby allowing the equipment to operate in closer proximity than manually controlled equipment.

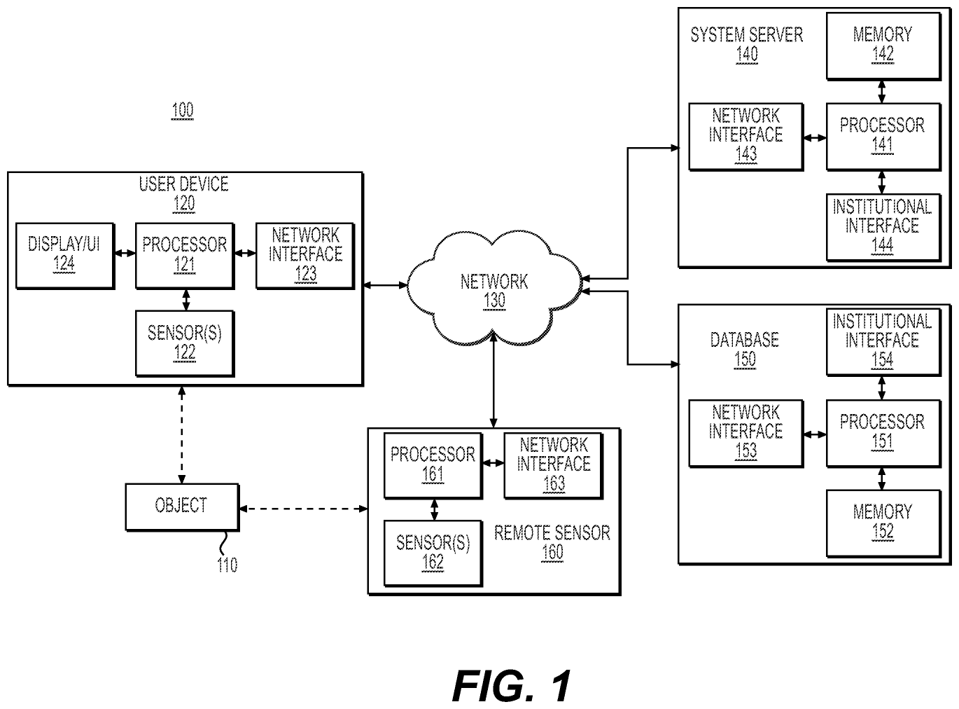

FIG. 1 depicts an exemplary system environment 100 that may be utilized with techniques presented herein. For example, the environment may include an object 110 (e.g., a vehicle or other article) to be evaluated by the system, a user device 120, a network 130, a system server 140, a database 150, and one or more remote sensors 160. Object 110 may be observed by one or more of the other elements in system environment 100, and one or more elements in the system environment 100 can use those observations to determine the likelihood of autonomous control of an object.

Object 110 can be a vehicle moving through an airspace or navigating a roadway or other ground surface. User device 120 can be, for example, a computer, telephone, tablet, or other device that can provide a user with access to other elements in system environment 100, and in some embodiments, user device 120 may be associated with a user's vehicle, such as a navigation system or vehicle control system. User device 120 may include a processor 121, one or more sensors 122, a network interface 123 for communicating with other elements in system environment 100, and a display/user interface (UI) 124 to receive input from and/or provide information to, the user.

Display/UI 124 can be in communication with processor 121 to provide the user of the device with instructions and prompts to request information, as well as to allow the user to provide requested information to, for example, the system server 140. In some embodiments in accordance with the present disclosure, display/UI 124 may include one or more monitors, touchscreen panels, keyboards, keypads, mice/trackpads, and/or other suitable devices for displaying information to, and/or for receiving inputs from, users of user device 120. User device 120 may be capable of allowing a user to, for example and not limitation, submit a request for a determination of the likelihood that object 110 is under autonomous control, provide observation data regarding object 110 collected using, e.g., sensors 122, and receive an autonomous operation score regarding object 110 via display/UI 124.

Sensor(s) 122 may be, for example, a camera or a Lidar system capable of capturing images or other representations of the appearance and/or motion of object 110, a microphone or other audio monitoring system capable of observing sounds produced by or associated with object 110, a wireless scanner configured to monitor wireless signals transmitted or received by object 110, and or any other implements through which object 110 may be observed to collect observation data. In some embodiments, sensor(s) 122 can be an integral part of user device 120, and in some embodiments one or more sensors 122 may be connected to user device 120 via a wired or wireless connection to provide user device 120 with observation data.

According to the present disclosure, the user of user device 120 can be, for example, a person or control system configured to operate or control a user's object (e.g., vehicle). In some embodiments, the user may be a control system that is directly associated with a user's vehicle or other system, for example, an adaptive cruise control system, a lane departure warning system, and/or an autonomous navigation system.

Network interface 123 of user device 120 may communicate with other elements of the system environment 100 via network 130. Network 130 may be implemented as, for example, the Internet, a wireless network, a wired network (e.g., Ethernet), a local area network (LAN), a Wide Area Network (WANs), Bluetooth, Near Field Communication (NFC), or any other type of network or combination of networks that provides communications between one or more components of the system environment 100. In some embodiments, the network 130 may be implemented using a suitable communication protocol or combination of protocols such as a wired or wireless Internet connection in combination with a cellular data network.

In order to transmit and receive data (e.g., request data, observation data, autonomous operation score), user device 120 may use network interface 123 to communicate, via network 130, with system server 140. System server 140 may include a processor 141 to execute instructions, a memory 142, a network interface 143 with which to communicate with other elements in system environment 100. System server 140 may also include an institutional interface 144, in addition to or in combination with network interface 143, which may enable system server 140 to communicate securely with database 150. Information, including instructions to be executed by processor 141, may be stored in memory 142.

Database 150 may be, for example, a secure server or other system associated with an institution and on which information, such as vehicle references and interaction data, may be stored. Database 150 may include a processor 151 which may execute instructions stored in a memory 152 in order to allow database 150 to receive and store data received via a network interface 153 and/or an institutional interface 154, and may also allow database 150 to respond to inquiries for information, such as requests for reference and/or observational data. In some embodiments, database 150 may be integral with system server 140, and/or functionally integral with system server 140.

Remote sensors 160 may be positioned throughout an environment, such as an airspace and/or roadway, to observe object 110 (e.g., vehicle). Remote sensors 160 may be for example, traffic cameras, microphones, radar systems, air traffic control systems, wireless scanners, and/or other implements with which the environment may be observed to collect observation data. Remote sensors 160 may include a processor 161 which may communicate with and/or operate one or more sensors 162. Each of the sensors 162 can be configured to collect observational data relating to object 110, and that observational data can be transmitted, via network interface 163 and network 130, to one or more of user device 120, system server 140, and/or database 150.

Although depicted as separate components in FIG. 1, it should be understood that a component or portion of a component may, in some embodiments, be integrated with or incorporated into one or more other components. For example, user device 120, database 150, and/or remote sensors 160 may be associated with an institution such that one or more elements may be considered to be a portion of the system server 140. Further, while a remote sensor 160 is depicted, remote sensors 160 may be a part of a network or service that provides observation data regarding, for example, airspaces and/or roadways (e.g., traffic camera, air traffic control).

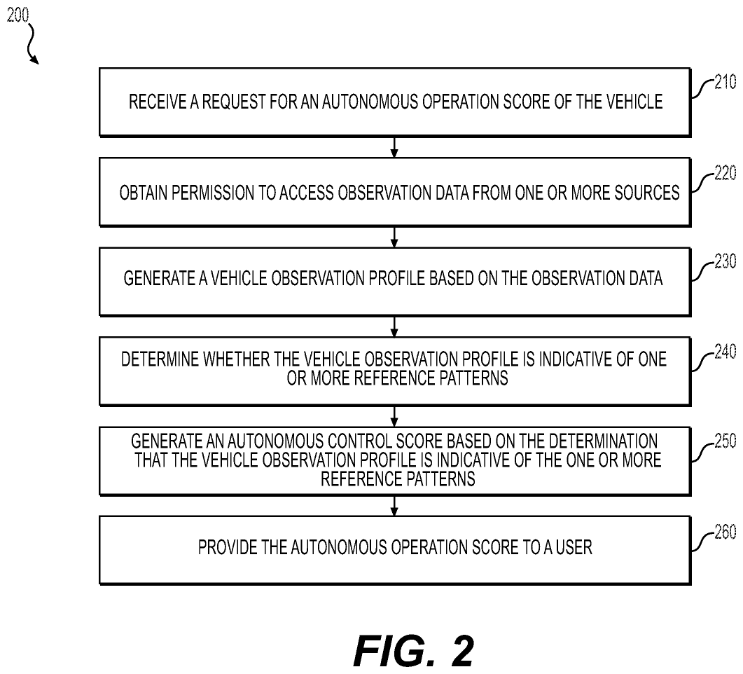

FIG. 2 depicts a flowchart illustrating a method 200 for determining the likelihood that a vehicle is under autonomous control, according to one or more embodiments of the present disclosure. Method 200 may be performed by one or more of the devices that comprise the system environment 100, for example and not limitation, by user device 120, system server 140, database 150, or a combination thereof.

Method 200 may begin at step 210 with the receipt of a request for an autonomous operation score for object 110. A user desiring to determine if object 110 is being operated autonomously or by a human operator may provide a request for an analysis of object 110, for example, via user device 120. The user may interact with UI 124 to provide sufficient information for user device 120 and/or system server 140 to be able to identify the object 110 to be analyzed. This information can be provided in a number of ways including, for example, selecting a representation of object 110 displayed on UI 124, aiming one or more sensor(s) 122 at object 110, inputting vehicle identifying information such as a serial or license plate number, and/or specifying a range or area within which to observe any objects 110.

For example, in some embodiments, UI 124 includes a representation of an environment, such as an airspace or roadway, with video or other visual representations of objects in the environment. The user can then provide an indication on UI 124 of user device 120 that allows user device 120 and/or system server 140 to determine an object 110 to be observed and analyzed. In some embodiments, sensor(s) 122 of user device 120 can include optical sensors, such as a camera, that a user can use to scan an environment. In some embodiments, UI 124 has access to real-time monitoring of an environment prior to the request, for example, when a user's vehicle has sensor(s) 122 that continuously monitor the environment surrounding the user's vehicle, such as a lane departure monitoring system, collision avoidance system, adaptive cruise control, or other vehicle operation assistance system. The monitoring being conducted by a user's vehicle may be used to display potential vehicles to be tracked on UI 124. Regardless of the source of the environmental information, the user may be able to indicate which object 110 is to be the subject of the analysis.

In some embodiments, the request may be received from a user such as a vehicle control or other such system. In some situations, the vehicle control system may generate the requests for an autonomous operation score for object 110 to be continuous, occur at regular intervals, and/or be automatically generated in response to criteria being met (e.g., in anticipation of a change of course of the user vehicle, in response to a sound or signal from the object 110). In some applications, the initial request may include instructions to continue to monitor the identified object 110 on an ongoing or periodic basis, and/or provide context such as the urgency of the request.

Upon receipt of the request and identification of object 110, at step 220, user device 120 and/or system server 140 may obtain permissions to access observation data from one or more sources of information regarding object 110. User device 120 and/or system server 140 may need access to the implements through which object 110 may be observed to collect observation data. These permissions may include, for example, user permissions to access sensor(s) 122 of user device 120, institutional permissions to connect to remote sensors 160, and/or credentials with which to connect to database 150. For example, database 150 may include information regarding the vehicle (e.g., specifications, communication protocols, features), the environment (e.g., regulations pertaining to the location, weather conditions), and/or other potential sources of object or observation data. Obtaining permissions can include initiating connections to one or more of the observational elements in system environment 100 (e.g., sensor(s) 122, remote sensors 160) and/or communicating the request and user permissions to system server 140 and/or database 150 to allow observation data to be accessed.

Having obtained access to observation data, at step 230, user device 120 and/or system server 140 can generate a vehicle observation profile based on the observation data. Generating the vehicle observation profile can include collecting and aggregating the observation data pertaining to object 110, and can also include structuring the observation data in a form suitable for subsequent analysis. The resulting vehicle observation profile may include information regarding the motion of object 110, the appearance of object 110, audio information relating to sounds that may be related to object 110, responses of object 110 to queries, network traffic detected going to or from object 110, the identification of potential operators of object 110, or any other observations that may be relevant to the determination of whether object 110 is being operated autonomously.

Once the vehicle observation profile is generated, at step 240, system server 140 may proceed to determine whether the vehicle observation profile is indicative of reference patterns associated with human operation or autonomous operation. To begin the analysis, system server 140 may access historical or other reference data to identify one or more reference patterns. The historical and/or reference data may be stored in, for example, memory 142 or database 150. This reference data may be generated and/or compiled by system server 140 and/or database 150, and may be based on prior observation data associated with a previous vehicle, including data for which the previous vehicle was known to be operated autonomously or by a human, as well as unlabeled data. In some embodiments, reference data can also be gleaned from known autonomous vehicle operation systems, such as knowing how an autonomous car is programmed to respond to the environment.

System server 140 may then analyze the vehicle observation profile to determine the existence of one or more observed patterns in the vehicle observation profile. These observed patterns may include aspects of the vehicle observation profile such as the smoothness of the motion of object 110, responses of object 110 to the environment or queries from user device 120 or system server 140, and/or patterns of signals received and transmitted by object 110. In some embodiments, the analysis of the vehicle observation profile to identify observed patterns can be conducted with respect to the reference patterns.

The identified observed patterns may then be compared to the one or more reference patterns. This comparison may be done by system server 140 and/or database 150, and may enable system server 140 to determine which, if any, reference patterns of which the observed patterns may be indicative. In some embodiments, the reference data may be used to train a machine learning model to aid in the determination of whether the vehicle observation profile is indicative of the autonomous reference patterns and/or the human reference patterns.

Based on the determination of the reference patterns the vehicle observation profile is indicative of, at step 250, an autonomous control score can be generated to reflect the likelihood that the vehicle is under autonomous control. This autonomous control score may take the form of a prediction including a confidence interval, a likelihood or probability of autonomous operation, and/or another manner of communicating the analysis and determination to the user. While the autonomous control score is based on the analysis and determination of the reference patterns the vehicle observation profile is indicative, the generation of the autonomous control score may also be based on other circumstances, for example, circumstances of user device 120 and/or the environment in which object 110 is present.

As used herein, a “machine learning model” is a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

At step 260, system server 140 may provide the user, for example, via UI 124 on user device 120, with the autonomous control score and/or other feedback based on the autonomous control score that can help the user determine the likelihood that the vehicle is being operated autonomously. The user may then be able to make operational decisions based on the assessed likelihood that object 110 is under autonomous as compared to human control. An operational decision may be, for example, a decision regarding whether or not to operate a user's vehicle, whether or not to operate a user's vehicle in a particular portion of the airspace or roadway, or whether or not to attempt to communicate with object 110. In some embodiments, the user may be a vehicle control system or other autonomous or semi-autonomous system, and the operational decision may be made directly in response to the autonomous control score and/or other feedback based on the autonomous control score.

In some situations, for example, the operational decision may be whether or not to modify an operational parameter of a user's vehicle based on the autonomous operation score, such that the user can operate the user's vehicle based on the modified operational parameters. For example, operational parameters can include a vehicle speed or direction, such as moving the user's vehicle to give more leeway to object 110.

Accordingly, methods and systems in accordance with the present disclosure may provide for improvements in navigation and/or resource protection. Considering the resources and/or safety concerns that may be at stake for the user, the amount of information to be collected, and the great many factors that may factor into the ultimate determination, methods and systems in accordance with the present disclosure may provide an accurate assessment of the observed behavior and other features of the vehicle to allow the user to expeditiously take appropriate action.

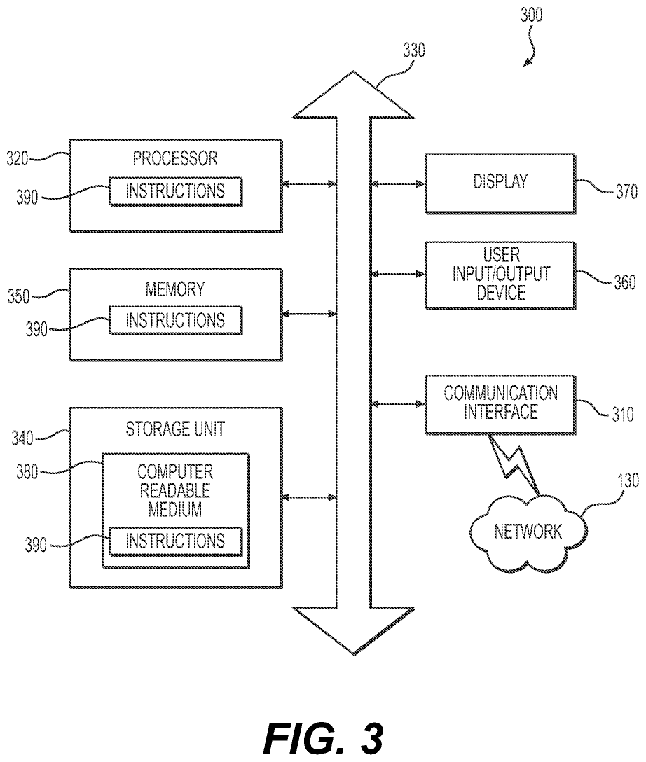

FIG. 3 is a simplified functional block diagram of a computer 300 that may be configured as a device for executing the method of FIG. 2, according to exemplary embodiments of the present disclosure. For example, the computer 300 may be configured as user device 120, system server 140, database 150, and/or another system according to exemplary embodiments of the present disclosure. In various embodiments, any of the systems herein may be a computer 300 including, for example, a data communication interface 310 for packet data communication via network 130. The computer 300 also may include a central processing unit (“CPU”) 320, in the form of one or more processors, for executing program instructions. The computer 300 may include an internal communication bus 330, and a storage unit 340 (such as ROM, HDD, SDD, etc.) that may store data on a computer readable medium 380, although the computer 300 may receive programming and data via network communications. The computer 300 may also have a memory 350 (such as RAM) storing instructions 390 for executing techniques presented herein, although the instructions 390 may be stored temporarily or permanently within other modules of computer 300 (e.g., processor 320 and/or computer readable medium 380). The computer 300 also may include input and output ports 360 and/or a display 370 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method of determining a likelihood of autonomous control of a vehicle, the method comprising:
receiving a request for an autonomous operation score of the vehicle;
obtaining one or more permissions to access observation data from one or more sources;
generating a vehicle observation profile based on the observation data from the one or more sources;
determining whether the vehicle observation profile is indicative of one or more reference patterns;
generating an autonomous control score based on the determination that the vehicle observation profile is indicative of the one or more reference patterns; and
providing the autonomous operation score to a user.

2. The method of claim 1, wherein the request includes an identification of the vehicle.

3. The method of claim 1, wherein obtaining the one or more permissions includes receiving at least one permission from the user to access one of the one or more sources.

4. The method of claim 1, wherein the one or more sources include a camera, and the observation data includes information regarding motion of the vehicle.

5. The method of claim 1, wherein the one or more sources include a microphone, and the observation data includes information regarding sound produced by the vehicle.

6. The method of claim 1, wherein the one or more sources include a wireless scanner, and the observation data includes information regarding one or more wireless signals transmitted or received by the vehicle.

7. The method of claim 1, wherein determining whether the vehicle observation profile is indicative of the one or more reference patterns includes determining existence of observed patterns in the vehicle observation profile, and comparing the observed patterns to the one or more reference patterns.

8. The method of claim 1, wherein the one or more reference patterns are generated based at least in part on prior observation data associated with at least one previous vehicle for which an operator of the at least one previous vehicle was known.

9. The method of claim 1, further including:
modifying one or more operational parameters of a user vehicle based at least in part on the autonomous operation score; and
operating the user vehicle based on the modified one or more operational parameters.

10. The method of claim 9, wherein the one or more operational parameters of the user vehicle includes one or both of a user vehicle speed or a user vehicle direction.

11. A system for determining a likelihood of autonomous control of a vehicle, the system comprising:
a memory storing instructions; and
a processor executing the instructions to perform a process including:
receiving a request for an autonomous operation score of the vehicle;
obtaining one or more permissions to access observation data from one or more sources;
generating a vehicle observation profile based on the accessed observation data from the one or more sources;
determining whether the vehicle observation profile is indicative of one or more reference patterns;
generating an autonomous control score based on the determination that the vehicle observation profile is indicative of the one or more reference patterns; and
providing the autonomous operation score to a user.

12. The system of claim 11, wherein the request includes an identification of the vehicle.

13. The system of claim 11, wherein obtaining the one or more permissions includes receiving at least one permission from the user to access one of the one or more sources.

14. The system of claim 11, wherein the one or more sources include a camera, and the observation data includes information regarding motion of the vehicle.

15. The system of claim 11, wherein the one or more sources include a microphone, and the observation data includes information regarding sound produced by the vehicle.

16. The system of claim 11, wherein the one or more sources include a wireless scanner, and the observation data includes information regarding one or more wireless signals transmitted or received by the vehicle.

17. The system of claim 11, wherein the one or more reference patterns are generated based at least in part on prior observation data associated with at least one previous vehicle for which an operator of the at least one previous vehicle was known.

18. The system of claim 11, further including:
modifying one or more operational parameters of a user device based at least in part on the autonomous operation score; and
operating the user device based on the modified one or more operational parameters.

19. The system of claim 18, wherein the user device is a user vehicle, and wherein the one or more operational parameters of the user device includes one or both of a user vehicle speed or a user vehicle direction.

20. A system for determining a likelihood of autonomous control of a moving object, the system comprising:
one or more observational sensors including at least one camera;
a memory storing instructions; and
a processor executing the instructions to perform a process including:
receiving a request for an autonomous operation score of the moving object;
obtaining one or more permissions to access observation data from one or more sources;
generating a vehicle observation profile based on the accessed observation data from the one or more sources;
determining whether the vehicle observation profile is indicative of one or more reference patterns;
generating an autonomous control score based on the determination that the vehicle observation profile is indicative of the one or more reference patterns;
providing the autonomous operation score to a user; and
modifying at least one of a user vehicle speed or a user vehicle direction based at least in part on the autonomous operation score.
